(19) United States
(12) Patent Application Publication
(10) Pub. No.: US 2025/0128495 A1
(43) Pub. Date: Apr. 24, 2025

(54) SURFACE MATERIALS AND METHOD OF MANUFACTURE

(71) Applicant: Wilsonart LLC, Austin, TX (US)

(72) Inventors: Muyuan M. Ma, Austin, TX (US); Rajesh Ramamurthy, Temple, TX (US); Mahesh Subramanian, Centerville, OH (US); Adam Biedrzycki, Temple, TX (US)

(21) Appl. No.: 18/924,272

(22) Filed: Oct. 23, 2024

Related U.S. Application Data
(60) Provisional application No. 63/592,410, filed on Oct. 23, 2023.

(51) Int. Cl. B32B 3/30; B32B 29/00

(52) U.S. Cl. CPC B32B 3/30; B32B 29/005; B32B 2255/12; B32B 2255/26; B32B 2260/028; B32B 2260/046; B32B 2307/718; B32B 2451/00

(57) ABSTRACT

A decorative laminate lay-up includes a decorative laminate sheet assembly and a textured delivery assembly. The decorative laminate sheet assembly comprises an overlay paper layer. The textured delivery assembly includes a core layer having a top side and a bottom side, with a decorative sheet, a textured protective film, and a textured substrate assembly. The decorative laminate lay-up is used in the manufacture of decorative laminates.

### CROSS-REFERENCE TO RELATED APPLICATIONS

This application claims the benefit of U.S. Provisional Patent Application Ser. No. 63/592, 410, entitled “SURFACE MATERIALS AND METHOD OF MANUFACTURE,” filed Oct. 23, 2023, which is incorporated herein by reference.

### BACKGROUND OF THE INVENTION

### 1. Field of the Invention

The present invention generally relates to surface materials and methods for manufacturing the surface materials.

### 2. Description of the Related Art

High pressure decorative laminates are currently manufactured with smooth glossy surfaces, textured surfaces, or deeply sculpted and embossed surfaces. As general background, decorative laminates prepared by heat and pressure consolidation have been produced commercially for a number of years, and have found widespread acceptance in the building and furniture industries as countertops and tabletops, bathroom and kitchen work surfaces, wall paneling, flooring products, partitions, and doors. These decorative laminates may be described as containing a number of laminae consolidated to form a unitary structure carrying a surface decoration. The surface decoration may range from something as simple as a solid color to something as complex as an embossed simulated wood grain finish.

Decorative laminates generally include plural layers of synthetic resin impregnated paper sheets bonded under heat and pressure to form a unitary structure. In normal practice, a decorative laminate sheet assembly, from the bottom up, includes a core of one or more phenolic resin impregnated sheets, above which lies a decorative melamine-formaldehyde impregnated sheet. The decorative sheet may be further covered with a melamine-formaldehyde impregnated overlay. The core, or base, functions to impart rigidity to the decorative laminate and usually includes a solid substrate which may, or may not, be formed prior to the initial laminating steps. Prior to stacking, the sheets of the core member are impregnated with a water alcohol solution of phenol formaldehyde, dried and partially cured in a hot oven, and finally cut into shapes.

The core may, for example, include a plurality of sheets of 90-150 pound phenolic resin impregnated Kraft paper. The Kraft paper is impregnated throughout and bonded with a substantially completely cured phenolic resin which has been converted to a thermoset state during the initial laminating step. The substrate may be a pre-cured plastic laminate, such as glass fiber-reinforced thermoset polyester resin laminates and the like, a wood product, such as hardboards, wood waste or particle boards, plywoods and the like, a mineral base board, such as, cement-asbestos boards, sheet rocks, plaster boards, and the like, or a combination of substrates.

The decorative sheet provides the decorative laminate with an attractive appearance. The decorative sheet also dictates the surface characteristics of the decorative laminate. For example, the composition of the decorative sheet dictates the decorative laminate's resistance to chemical agents, heat, light, shock, and abrasion. Decorative sheets are commonly manufactured from high quality 50-125 pounds per 3,000 square ft. ream basis weight (80-202 grams per square meter), pigment filled, alpha-cellulose paper impregnated with a water alcohol solution of melamine-formaldehyde resin. The resin impregnated decorative sheets are subsequently dried, partially cured, and finally cut into sheets. The pigment filled, alpha-cellulose paper of the decorative sheet, may include a solid color, a decorative design, or a roto-gravure reproduction of natural materials, such as, wood, marble, leather, etc. The aesthetic characteristics of the cellulose paper are revealed as the laminate's decorative design upon completion of the decorative laminate.

Decorative laminates are generally manufactured by placing the resin impregnated core and decorative sheet between steel plates and subjecting the decorative laminate stack to heat and pressure for a time sufficient to consolidate the laminate and cure the resins (generally about 25 minutes to an hour). The pressure and heat force the resin in the paper sheets to flow, cure, and consolidate the sheets into a unitary laminated mass referred to in the art as a decorative high pressure laminate. Finally, the formed decorative laminate is bonded to a reinforcing substrate, such as, plywood, hardboard, asbestos board, particle board or the like.

Generally, more than one laminate is formed at one time. Multiple laminates are formed by inserting a plurality of decorative laminate sheet assemblies into a stack. Release sheets are positioned between the decorative laminate sheet assemblies to separate the various laminates stacked together. After consolidation, the release sheets allow the individual laminates to be separated.

Textured decorative laminates are also very popular. The textured surfaces range from relatively shallow depressions, such as, textured (e.g., satin, matte, or semi-gloss) surfaces, to relatively deeply sculpted or embossed surfaces having a noticeable three-dimensional effect, such as, wood grain, leather, slate, abstract patterns, creative designs, etc. The textured laminates are commonly manufactured using release sheets with the desired surface texture, which surface texture is imparted to the decorative laminate during the application of heat and pressure in the manufacturing process.

It has, however, been found that high pressure decorative laminates are susceptible to the build-up of fingerprints as the surface of the high pressure decorative laminate is touched during the course of the day. The fingerprints remain visible and can become highly distracting. Prior attempts to address this problem have relied upon chemically modified surfaces. However, such attempts have only led to limited success. As such, a need remains for a high pressure decorative laminate that is not susceptible to the build-up of fingerprints on the surface thereof.

### SUMMARY OF THE INVENTION

In one aspect a decorative laminate lay-up includes a decorative laminate sheet assembly and a textured delivery assembly. The decorative laminate sheet assembly comprises an overlay paper layer. The textured delivery assembly includes a core layer having a top side and a bottom side, with a decorative sheet, a textured protective film, and a textured substrate assembly. The decorative laminate lay-up is used in the manufacture of decorative laminates.

In some embodiments the decorative layer is a decorative sheet of unimpregnated paper.

In some embodiments the decorative sheet of unimpregnated paper is a paper sheet manufactured from high quality 80-202 grams per square meter ream weight, pigment filled, alpha cellulose paper.

In some embodiments the overlay paper layer is a low basis weight paper.

In some embodiments the low basis weight paper layer is impregnated with melamine-formaldehyde resin.

In some embodiments, before impregnation with resin, the paper of the overlay paper layer is treated with electron beam irradiation to prepare the overlay paper layer for resin impregnation.

In some embodiments the core layer is composed of a plurality of phenolic resin impregnated sheets.

In some embodiments the textured protective film includes a solvent-free and non-aqueous lacquer.

In some embodiments the lacquer is an acrylate mixture comprised of epoxy acrylic or a urethane acrylic.

In some embodiments the textured substrate assembly is formed by applying the acrylate mixture, upon a first side of a substrate and the acrylate mixture is irradiated with UV-radiation to a create a UV-irradiated layer.

In some embodiments applying the acrylate mixture includes laying the epoxy acrylic or urethane acrylic upon the first side of the substrate.

In some embodiments irradiation is applied so that the acrylate mixture is neither hardened nor entirely crosslinked, wherein the acrylate mixture is only crosslinked on an exposed surface thereof thereby producing a matte surface on the exposed surface through effects of micro-convolution.

In some embodiments the textured substrate assembly includes a textured substrate layer that includes a first side facing the substrate and a second side facing away from the substrate and upon which the matte surface is formed.

In some embodiments the textured substrate assembly, which is composed of the textured substrate layer and the substrate, is a unitary structure that will not delaminate during a laminate production process.

In some embodiments a second layer of the acrylate mixture, which ultimately becomes the textured protective film, is then applied to the exposed surface of the epoxy acrylic or urethane acrylic UV cured textured substrate layer.

In some embodiments the second layer of the acrylate mixture is subjected to a UV precure and the decorative layer is wet laminated to the exposed surface thereby completing the textured delivery assembly and the textured delivery assembly is ready for application to the overlay paper layer.

In some embodiments the second layer of the acrylate mixture second layer is applied to the textured substrate layer such that the texture of the textured substrate layer is ultimately applied to a top first surface of the textured protective film, the second layer of the acrylate mixture is only temporarily applied to the textured substrate layer and the textured substrate assembly is ultimately separated from the textured protective film to reveal the textured surface.

In some embodiments the first side of the textured substrate layer is ultimately imparted to a top layer of the decorative laminate, and a resulting decorative laminate is provided with a top surface having matte texture that is the same as that of the textured surface of textured substrate layer.

In another aspect a method for forming a decorative laminate comprises forming a decorative laminate lay-up comprising a decorative laminate sheet assembly comprised of an overlay paper layer, a decorative layer, and a core layer, and a textured delivery assembly including a top side and a bottom side, with a decorative sheet, a textured protective film, and a textured substrate assembly. The decorative laminate lay-up is used in manufacture of decorative laminates. The method also includes applying heat and pressure are to the laminate sheet assembly and the textured delivery assembly using press plates in a conventional manner, wherein the heat and pressure are applied in a manner sufficient to bond the layers of the decorative laminate sheet assembly.

In some embodiments, during the heating and pressure molding process, melamine-formaldehyde resin of the overlay paper layer, which is positioned directly below the decorative layer, will liquefy, flow, and cure into a thermoset polymer, and during a flow phase some of the melamine-formaldehyde resin will diffuse into the decorative layer to ensure that consolidation between the decorative layer, the overlay paper layer, and the core layer.

In some embodiments, during the pressing under heat, phenol-formaldehyde resin of the core layer will also liquefy, flow, and cure into a thermoset polymer, like a normal high pressure decorative laminate product, and some of the phenol-formaldehyde liquid resin will mix with the melamine-formaldehyde resin of the overlay paper layer above it, as normally happens during the production of high pressure decorative laminate.

Other objects and advantages of the present invention will become apparent from the following detailed description when viewed in conjunction with the accompanying drawings, which set forth certain embodiments of the invention.

### BRIEF DESCRIPTION OF DRAWINGS

FIG. 1 is a schematic of a laminate lay-up in accordance with an embodiment of the present invention.

FIGS. 2, 3, and 4 are schematics showing the formation of the textured substrate assembly.

FIGS. 5 and 6 are schematics showing the application of the second layer to the

textured substrate assembly.

FIG. 7 is a schematic showing the final formation of the textured delivery assembly.

FIG. 8 is a schematic of the resulting decorative laminate.

### DETAILED DESCRIPTION OF THE INVENTION

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

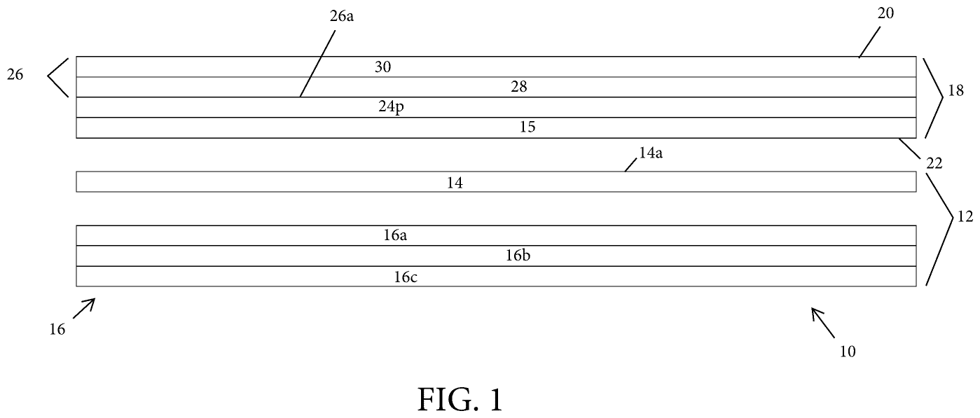

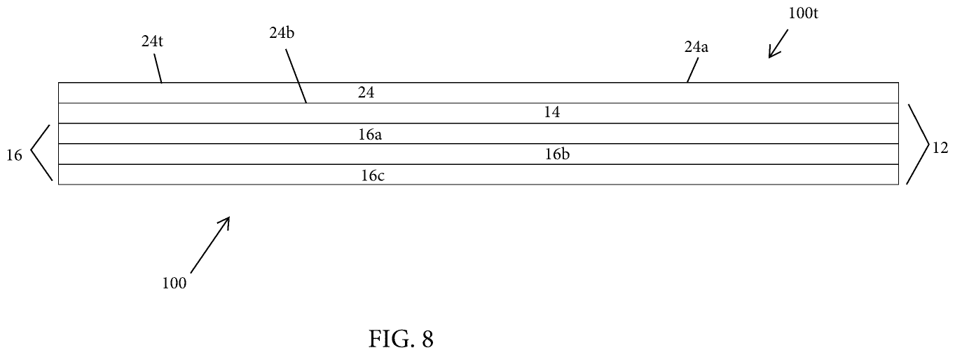

With reference to FIG. 1, a decorative laminate lay-up 10 includes a decorative laminate sheet assembly 12 (composed of an overlay paper layer 14 and a core layer 16 as discussed below in greater detail) and a textured delivery assembly 18 (including a top side 20 and a bottom side 22, with a decorative sheet 15, a textured protective film 24, and a textured substrate assembly 26). The decorative laminate lay-up 10 is used in the manufacture of decorative laminates 100 (see FIG. 8) in accordance with an embodiment of the present invention. The decorative laminate lay-up 10 is assembled in a traditional manner; that is, the sheets used in the production of the decorative laminate 100 are stacked in preparation for the heating and pressure steps used to consolidate the laminate.

Decorative layers 15 are chosen from a wide array of sheets. For example, the decorative layer 15 may be a solid color (for example, white) or include an aesthetically appealing pattern. As discussed above, the decorative layer 15 provides the decorative laminate 100 with an attractive appearance. The textured protective film 24 and the decorative layer 15 also dictate the surface characteristics of the final decorative laminate 100. For example, the composition of the textured protective film 24 and decorative layer 15 help to dictate the decorative laminate's resistance to chemical agents, heat, light, shock, and abrasion.

In accordance with a disclosed embodiment, the decorative layer 15 is a decorative sheet of unimpregnated paper (that is, prior to heating and pressing during which resin will flow into the decorative sheet), in particular, a paper sheet manufactured from high quality 80-202 grams per square meter ream weight, pigment filled, alpha cellulose paper. The pigment filled, alpha cellulose paper of the decorative sheet, may include a solid color, a decorative design, or a photo-gravure reproduction of natural materials, such as, wood, marble, leather, etc. The aesthetic characteristics of the cellulose paper are revealed as the laminate's decorative design upon completion of the decorative laminate.

As to the overlay paper layer 14, it is a low basis weight paper, for example, an overlay type paper, defining a low basis weight paper layer, that has been impregnated with melamine- formaldehyde resin. The overlay paper layer 14 is preferably manufactured from a low basis weight transparent paper sheet impregnated with resin, for example, melamine-formaldehyde. Before impregnation with resin, the paper of the overlay paper layer 14 is treated with electron beam irradiation to prepare the surface of the paper for resin impregnation. This treatment improves the wettability of the paper of the overlay paper layer 14. The resin impregnated overlay paper layer 14 is subsequently dried, partially cured and finally cut into sheets. In accordance with a preferred embodiment, the overlay paper layer 14 is B-stage cured and then ready for use. Ultimately, the decorative layer 15 is a conventional pattern sheet positioned directly above the overlay paper layer 14.

The core layer 16 is preferably composed of a plurality of phenolic resin impregnated sheets 16a, 16b, 16c, although other materials may be used without departing from the spirit of the present invention. For example, the core layer 16 includes sheets of 120-323 grams per square meter dry phenolic resin impregnated Kraft paper. The Kraft paper is impregnated throughout and bonded with a substantially cured phenolic resin which is converted to a thermoset state during the initial laminating step.

The textured protective film 24 includes a solvent-free and non-aqueous lacquer (in accordance with the present invention the lacquer is preferably an epoxy acrylic or a urethane acrylic (also referred to herein as the acrylate mixture)). The textured protective film 24 is formed as part of the textured delivery assembly 18 allowing the application of the textured protective film 24 to the top surface of the decorative sheet 15.

The process for producing surface effects in the textured protective film 24 applies techniques taught in European Patent Application Publication No. 2527408, entitled “Method for Producing a Film with a Matt Surface,” which is incorporated herein by reference. Briefly, and as will be appreciated based upon the following disclosure, the '408 publication teaches a technique for producing surface effects on a sheet. In accordance with the disclosed methodology a coating of an electron beam radiation curable material is applied to one surface of a web substrate, and subsequently cured (ultimately producing the textured substrate assembly 26 with a textured matte surface 26a that is ultimately transferred to the textured protective film 24 in accordance with the present invention). The surface forming techniques of the '408 publication result in a textured protective film 24 with a textured matte top first surface 24a. The textured matte top first surface 24a exhibits good matting properties (and correspondingly low degrees of gloss as defined in and measured in accordance with DIN EN ISO 2813) having improved scratch resistance properties. Ultimately, and as will be explained below in greater detail, the film produced as a result of the manufacturing process disclosed in the '408 publication is ultimately utilized as a release sheet in the manufacture of decorative laminate.

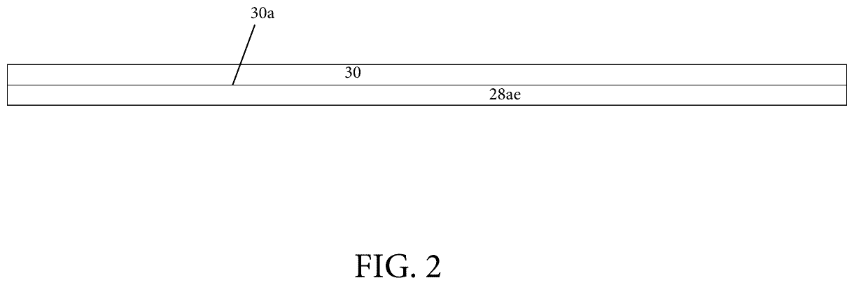

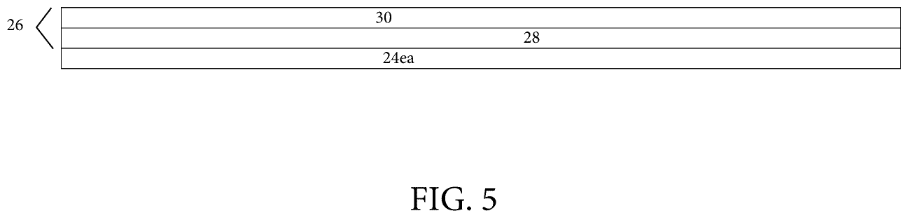

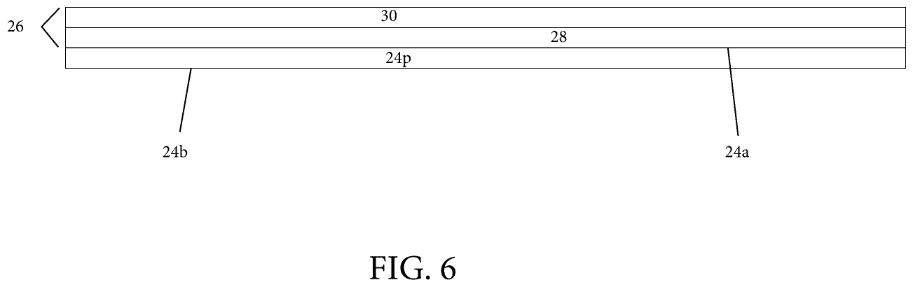

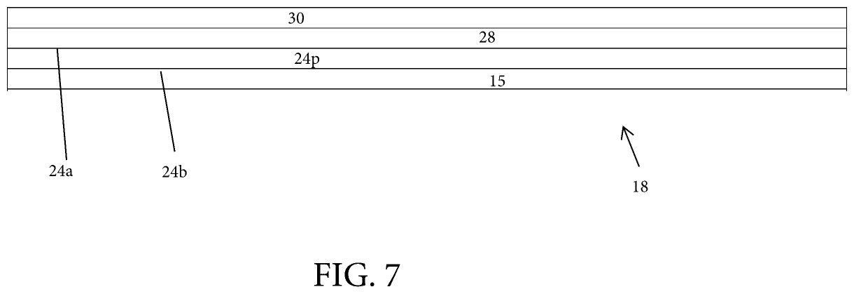

More specifically, and with reference to FIGS. 2 to 7, the textured protective film 24, employs a solvent-free and non-aqueous lacquer (preferably an epoxy acrylic or a urethane acrylic (also referred to herein as the acrylate mixture)) in the production of the textured matte top first surface 24a on the textured protective film 24. The textured protective film 24 is produced through the implementation of a multi-stage irradiation and manufacturing process utilizing a textured delivery assembly 18.

First, and with reference to FIGS. 2, 3, and 4, a textured substrate assembly 26 is produced. In accordance with a disclosed embodiment, the textured substrate assembly 26 is formed by applying the UV curable acrylate mixture 28ae, that is, epoxy acrylic or urethane acrylic (which is ultimately cured to form the textured substrate layer 28 of the textured substrate assembly 26) is laid, or otherwise applied, upon a first side 30a of a substrate 30 and the UV curable acrylate mixture 28ae is irradiated with UV-radiation to a create a UV-irradiated layer 28m. However, the irradiation is applied so that the UV curable acrylate mixture 28ea is neither hardened nor is the entire layer of UV curable acrylate mixture 28ae crosslinked. Rather the UV curable acrylate mixture 28ea is only crosslinked on the exposed surface 28s thereof, that is, the surface of the UV curable acrylate mixture 28ae facing away from the substrate 30. This produces a matte surface on the exposed surface 28s through the effects of a micro-convolution. In accordance with a preferred embodiment, and as will be discussed below in more detail, the UV-radiation irradiates via an excimer laser emitter based on a Xe-emission spectrum at a wavelength of 172 nm in the presence of nitrogen. The use of an excimer laser emitter results in a controlled cure of the UV curable acrylate mixture 28ae as the excimer laser emitter only results in a partial cure resulting in the desired micro-convolutions.

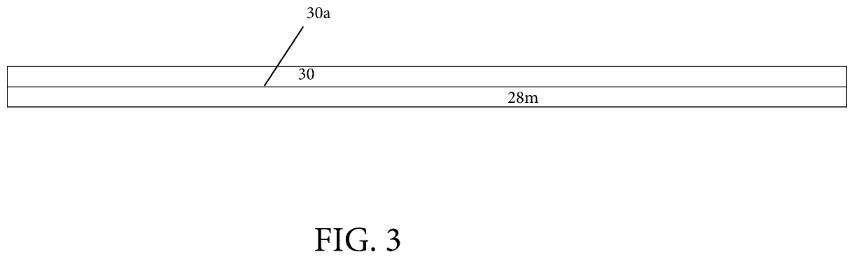

Referring to FIG. 3, the monochromatic UV-irradiated layer 28m (on the first side 30a of the substrate 30) is then subjected to an electron beam irradiation to crosslink and harden the entire layer and form the final textured substrate layer 28 of the textured substrate assembly 26.

This procedure initially creates a shrinking process in the UV curable acrylate mixture 28ea that ultimately becomes an epoxy acrylic or urethane acrylic UV cured textured substrate layer 28 on the first side 30a of the substrate 30. The textured substrate layer 28 includes a first side 28a facing the substrate 30 and a second side 28b facing away from the substrate 30 and upon which the matte surface is formed. As will be discussed below in more detail, the textured substrate assembly 26, which is composed of the textured substrate layer 28 and the substrate 30, is a unitary structure that will not delaminate during the laminate production process.

A second layer of the UV curable acrylate mixture 24ae, which ultimately becomes the textured protective film 24, is then applied to the exposed surface, that is, the matte second side 28b, of the epoxy acrylic or urethane acrylic UV cured textured substrate layer 28. The second layer of the UV curable acrylate mixture 24ae is then subjected to a UV precure and the decorative layer 15 is wet laminated to the exposed surface, that is, the top first surface 24a of the UV curable acrylate mixture second layer 24ae that ultimately defines the textured protective film 24. This completes the textured delivery assembly 18 (the decorative layer 15 and textured protective film 24 in combination with the textured substrate assembly 26 define the textured delivery assembly 18) and the textured delivery assembly 18 is ready for application to the overlay paper layer 14.

The UV curable acrylate mixture second layer 24ae is applied to the textured substrate layer 28 such that the texture 28t of the textured substrate layer 28 is ultimately applied to the top first surface 24a of the textured protective film 24. The UV curable acrylate mixture second layer 24ae is only temporarily applied to the textured substrate layer 28 and, as discussed below in detail, the textured substrate assembly 26 is ultimately separated from the textured protective film 24 to reveal the textured surface.

As the textured matte first side 28a of the textured substrate layer 28 is ultimately imparted to the top layer (that is, the texture 24t of the top first surface 24a of the textured protective film 24 in accordance with the present invention) of the decorative laminate 100, the resulting decorative laminate 100 is provided with a top surface 100a having matte texture 100t that is the same as that of the textured surface of textured substrate layer 28 and will exhibit desired resistance to the formation of fingerprints.

The production of a textured matte first side 28a of the textured substrate layer 28 is achieved according to the '408 publication with 100% lacquers, to which no separate matting agent (such as silica or the like) is added. The curing and cross-linking of the total layer by means of the heat and pressure applied during the consolidation of the laminate (as discussed below) fixes the matte surface created by the partial curing and irradiation without influencing the matte surface in any adverse manner. The textured protective film 24 produced through the application of this technique is distinguished by outstanding matting properties, which gloss levels to less than 3 (measured in accordance with the cited DIN EN ISO 2813 and 60° geometry) or less than 5 (corresponding at 85° geometry) can be reached.

In accordance with a preferred embodiment, the UV curable acrylate mixture 28ae is preferably applied to the substrate 30 by a roller, with a layer thickness greater than 5 microns and up to approximately 150 microns (preferably, 30 to 100 microns). The substrate 30 is selected from various substrate plastic materials, such as polyethylene terephthalate (PET) polyester or the like. In accordance with a preferred embodiment, a plastic film substrate of PET, layer thickness 150 microns, is coated by a roller with an epoxy acrylic or urethane acrylic mixture to produce a coating thickness of greater than 30 microns and up to approximately 150 microns (preferably, 40 to 80 microns), wherein the acrylate mixture, in accordance with one embodiment, has the following composition:
60% to 90%, by weight, urethane acrylate;
8% to 38%, by weight, reactive diluent, such as, isobornyl acrylate;
1.0% to 10%, by weight, photo initiator, for example, a combination of 0.5% to 5% by weight benzophenone and 0.5% to 5% by weight triethanol amine; and
0.5% to 5%, by weight, a thermal initiator, for example, tert-Butyl peroxybenzoate.

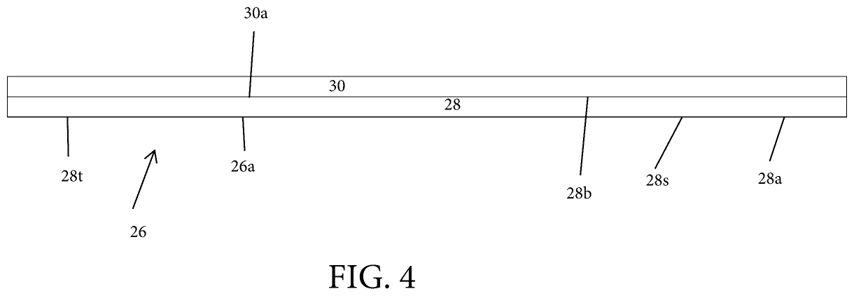

The substrate 30 coated with the UV curable acrylate mixture 28ae is then subjected to LED precure and is passed under an inert gas in a continuous (in-line) process under a 172 nm excimer laser emitter, with a typical feed of 60 m/min at 0.5 cm distance from the coating surface. This creates a UV-irradiated layer 28m having a surface exhibiting micro-folding (see FIGS. 3 and 4). In particular, the radiation is applied so that UV curable acrylate mixture 28ae is neither hardened nor is the entire layer of UV curable acrylate mixture 28ae crosslinked. Rather the UV curable acrylate mixture 28ae is only crosslinked on the surface thereof, which produces a supermatting surface through the effects of a micro-convolution. In accordance with a preferred embodiment, the UV-radiation irradiates via an excimer laser emitter based on a Xe-emission spectrum at a wavelength of 172 nm in the presence of nitrogen. The result is a partially cured surface, that is, the UV-irradiated layer 28m with a surface matting of gloss <4 (60° geometry, measured as before) which immediately is subjected thereafter to an electron beam crosslinking (and hence hardening) of the UV curable acrylate mixture 28ae to form the final, fully hardened epoxy acrylic or urethane acrylic UV cured texture substrate layer 28 with a radiation absorbed dose of 30 kGy.

In accordance with a specific embodiment, the UV curable acrylate mixture is as follows:
42% Ebecryl® 294/HD 25 (an aliphatic urethane triacrylate oligomer diluted with 1,6-hexanediol diacrylate (HDDA) (1) monomer.)
38% Ebecryl® 5129 (a hexafunctional aliphatic urethane acrylate oligomer which provides fast cure response when exposed to ultraviolet light or electron beam.)
9% Ebecryl® 8209 (a Sn-free aliphatic urethane acrylate oligomer which provides extremely fast cure response when exposed to ultraviolet (UV) light or electron beam (EB).)
5% HDDA/TMPTA (Hexanediol diacrylate (HDDA) is a difunctional reactive diluent that is commonly used as a component of ultraviolet light (UV) and electron beam (EB) curable coatings and inks. Trimethylolpropane triacrylate (TMPTA) is a trifunctional monomer used for its low volatility and fast cure response.)
2% Photoinitiator
2% Cerafak 127N (a Fischer Tropsch wax dispersion. Provides improved water repellence properties.)
1% TBPB (tert-Butyl peroxybenzoate (TBPB) a chemical compound from the group of peresters which functions as a radical initiator in a polymerization process
1% Modaflow 9200 (an acrylic flow modifier, without silicone addition. It improves flow and leveling, substrate wetting, or maintains high gloss and substrate and inter-coat adhesion, and facilitates pigment dispersion).

The second layer 24ea is then applied. The second layer 24ea uses the same UV curable acrylate mixture as is used in the creation of the initial layer of the UV curable acrylate mixture. In particular, the UV curable acrylate mixture is preferably applied to the cured textured substrate layer 28 of the textured substrate assembly 26 by a roller to form the UV curable acrylate mixture second layer 24ae, with a layer thickness greater than 5 microns and up to approximately 150 microns (preferably, 30 to 100 microns). The UV curable acrylate mixture second layer 24ae is then subjected to a UV precure to form the precured second layer 24p.

Finally, the decorative sheet 15 is applied to the exposed surface, that is, the exposed second surface 24b, of the precured second layer 24p that ultimately becomes the textured protective film 24. In particular, the decorative sheet 15 is applied via wet lamination to the tacky exposed second surface 24b of the precured second layer 24p. The textured delivery assembly 18 is now ready for use and is applied to the laminate sheet assembly 12 as discussed below.

In addition to the curing facilitated by the application of the UV and/or electron beam radiation, and as is discussed below in greater detail, the UV curable acrylate mixture second layer 24ae requires a final thermal curing step to fully cure the textured protective film 24. As will be explained below, the textured delivery assembly 18, with the textured protective film 24 thereon, is ultimately subjected to heat and pressure when the laminate lay-up is subjected to conventional high pressure laminate manufacturing through the application of pressure via press plates under traditional heating conditions. The ability to achieve the final curing of the UV curable acrylate mixture second layer 24ae during the application of heat during the pressing process results from the inclusion of peroxide (in the form of TBPB) in the acrylate mixture.

With the laminate sheet assembly 12 and the textured delivery assembly 18 prepared, the textured delivery assembly 18 is positioned on the upper surface 14a of the overlay paper layer 14, with the decorative sheet 15 facing the overlay paper layer 14, of the laminate sheet assembly 12 to form the laminate lay-up 10. The textured delivery assembly 18 is positioned on the overlay paper layer 14 with the top side (that is, the PET substrate 30) of the textured delivery assembly 18 facing away from the upper surface of the overlay paper layer 14.

Heat and pressure are then applied to the laminate sheet assembly 12 and the textured delivery assembly 18 using press plates in a conventional manner. The heat and pressure are applied in a manner sufficient to bond the layers of the decorative laminate sheet assembly 12.

Also, during the heating and pressure molding process the melamine-formaldehyde of the low basis weight paper layer, that is, the overlay paper layer 14, which is positioned directly below decorative layer 15, will liquefy, flow, and cure into a thermoset polymer. During the flow phase some of the melamine-formaldehyde resin will diffuse into the decorative layer 15. This will ensure that consolidation between the decorative layer 15, the low basis weight overlay paper layer 14, and the core layer 16. During the pressing under heat, the phenol-formaldehyde of the core layer 16 will also liquefy, flow, and cure into a thermoset polymer, like a normal high pressure decorative laminate product. Some of the phenol-formaldehyde liquid resin will mix with the melamine-formaldehyde resin of the low basis weight overlay paper layer 14 above it, as normally happens during the production of high pressure decorative laminate 100.

The heat and pressure also effectuate the final curing where peroxide (in the form of TBPB) is integrated into the textured protective film 24. Finally, the textured substrate assembly 26 is peeled from the textured protective film 24 (and the decorative layer 15) positioned atop, and securely bonded to, the decorative sheet 15 of the formed decorative laminate 100 revealing a decorative laminate 100 exhibiting desired matte texture characteristics.

In accordance with an embodiment of the present invention, the decorative laminate 100 of the present invention is formed in much the same manner as conventional decorative laminates. The layers are first stacked and placed between steel plates. The decorative laminate lay-up (or stack) 10 is then subjected to temperatures in the range of 121° C.-160° C. and pressures of about 56.24 kg/cm2 to 112.48 kg/cm2 for a time sufficient to consolidate the laminate and cure the resins (generally about 25 minutes to an hour).

The pressure and heat force the resin in the paper sheets to flow, cure and consolidate the sheets into a unitary laminated mass referred to in the art as a high pressure decorative laminate 100. Generally, more than one decorative laminate is formed at one time. As shown with reference to FIG. 1, multiple decorative laminates are formed by inserting a plurality of lay-ups 10 in a stack. Release sheets 40 are also positioned between the core layer 16 of the lay-ups 10 to separate the various decorative laminates stacked together. These release sheets 40 are positioned between the adjacent lay-ups 10 along the core layer sides. Upon pressing between suitable laminate press plates, the release sheet allows release between the first lay-up and the adjacent lay-up.

A platen press assembly, as is well known in the lamination art, provides the necessary heat and/or pressure during lamination. After consolidation, the release sheets allow the individual decorative laminates to be separated.

While the preferred embodiments have been shown and described, it will be understood that there is no intent to limit the invention by such disclosure, but rather, it is intended to cover all modifications and alternate constructions falling within the spirit and scope of the invention.

1. A decorative laminate lay-up, comprising:
a decorative laminate sheet assembly comprised of an overlay paper layer, a decorative layer, and a core layer; and
a textured delivery assembly including a top side and a bottom side, with a decorative sheet, a textured protective film, and a textured substrate assembly;
wherein the decorative laminate lay-up is used in manufacture of decorative laminates.

2. The decorative laminate lay-up according to claim 1, wherein the decorative layer is a decorative sheet of unimpregnated paper.

3. The decorative laminate lay-up according to claim 2, wherein the decorative sheet of unimpregnated paper is a paper sheet manufactured from high quality 80-202 grams per square meter ream weight, pigment filled, alpha cellulose paper.

4. The decorative laminate lay-up according to claim 2, wherein the overlay paper layer is a low basis weight paper.

5. The decorative laminate lay-up according to claim 4, wherein the low basis weight paper layer is impregnated with melamine-formaldehyde resin.

6. The decorative laminate lay-up according to claim 5, wherein, before impregnation with resin, the paper of the overlay paper layer is treated with electron beam irradiation to prepare the overlay paper layer for resin impregnation.

7. The decorative laminate lay-up according to claim 1, wherein the core layer is composed of a plurality of phenolic resin impregnated sheets.

8. The decorative laminate lay-up according to claim 1, wherein the textured protective film includes a solvent-free and non-aqueous lacquer.

9. The decorative laminate lay-up according to claim 8, wherein the lacquer is an acrylate mixture comprised of epoxy acrylic or a urethane acrylic.

10. The decorative laminate lay-up according to claim 9, wherein the textured substrate assembly is formed by applying the acrylate mixture, upon a first side of a substrate and the acrylate mixture is irradiated with UV-radiation to a create a UV-irradiated layer.

11. The decorative laminate lay-up according to claim 10, wherein applying the acrylate mixture includes laying the epoxy acrylic or urethane acrylic upon the first side of the substrate.

12. The decorative laminate lay-up according to claim 11, wherein irradiation is applied so that the acrylate mixture is neither hardened nor entirely crosslinked, wherein the acrylate mixture is only crosslinked on an exposed surface thereof thereby producing a matte surface on the exposed surface through effects of micro-convolution.

13. The decorative laminate lay-up according to claim 12, wherein the textured substrate assembly includes a textured substrate layer that includes a first side facing the substrate and a second side facing away from the substrate and upon which the matte surface is formed.

14. The decorative laminate lay-up according to claim 13, wherein the textured substrate assembly, which is composed of the textured substrate layer and the substrate, is a unitary structure that will not delaminate during a laminate production process.

15. The decorative laminate lay-up according to claim 12, wherein a second layer of the acrylate mixture, which ultimately becomes the textured protective film, is then applied to the exposed surface of the epoxy acrylic or urethane acrylic UV cured textured substrate layer.

16. The decorative laminate lay-up according to claim 15, wherein the second layer of the acrylate mixture is then subjected to a UV precure and the decorative layer is wet laminated to the exposed surface thereby completing the textured delivery assembly and the textured delivery assembly is ready for application to the overlay paper layer.

17. The decorative laminate lay-up according to claim 16, wherein the second layer of the acrylate mixture second layer is applied to the textured substrate layer such that the texture of the textured substrate layer is ultimately applied to a top first surface of the textured protective film, the second layer of the acrylate mixture is only temporarily applied to the textured substrate layer and the textured substrate assembly is ultimately separated from the textured protective film to reveal the textured surface.

18. The decorative laminate lay-up according to claim 17, wherein the first side of the textured substrate layer is ultimately imparted to a top layer of the decorative laminate, and a resulting decorative laminate is provided with a top surface having matte texture that is the same as that of the textured surface of textured substrate layer.

19. A method for forming a decorative laminate, comprising:
forming a decorative laminate lay-up comprising a decorative laminate sheet assembly comprised of an overlay paper layer, a decorative layer, and a core layer, and a textured delivery assembly including a top side and a bottom side, with a decorative sheet, a textured protective film, and a textured substrate assembly, wherein the decorative laminate lay-up is used in manufacture of decorative laminates;
applying heat and pressure are to the laminate sheet assembly and the textured delivery assembly using press plates in a conventional manner, wherein the heat and pressure are applied in a manner sufficient to bond the layers of the decorative laminate sheet assembly.

20. The method according to claim 19, wherein, during the heating and pressure molding process melamine-formaldehyde resin of the overlay paper layer, which is positioned directly below the decorative layer, will liquefy, flow, and cure into a thermoset polymer, and during a flow phase some of the melamine-formaldehyde resin will diffuse into the decorative layer to ensure that consolidation between the decorative layer, the overlay paper layer, and the core layer.

21. The method according to claim 20, wherein during the pressing under heat, phenol-formaldehyde resin of the core layer will also liquefy, flow, and cure into a thermoset polymer, like a normal high pressure decorative laminate product, and some of the phenol-formaldehyde liquid resin will mix with the melamine-formaldehyde resin of the overlay paper layer above it, as normally happens during the production of high pressure decorative laminate.
